(19) United States
(12) Patent Application Publication
(10) Pub. No.: US 2026/0355893 A1
(43) Pub. Date: Nov. 12, 2026

(54) DEVICE FOR SHARPENING A FISHING HOOK

(71) Applicant: David MEYN, Hamburg (DE)

(72) Inventor: David MEYN, Hamburg (DE)

(21) Appl. No.: 19/515,098

(22) PCT Filed: Sep. 3, 2024
(86) PCT No.: PCT/EP2024/074519

§ 371 Date: Feb. 27, 2026

(30) Foreign Application Priority Data
Sep. 4, 2023 (DE) 10 2023 123 677.6

(51) Int. Cl. B24B 19/16; A01K 83/00; A01K 97/00

(52) U.S. Cl. CPC B24B 19/16; A01K 97/00; A01K 83/00

(57) ABSTRACT

The disclosure relates to a device for sharpening a fishing hook, a fishing hook system, and a method for grinding a fishing hook. The device comprises a first grinding element having a first grinding surface with an abrasive layer, a second grinding element having a second grinding surface with an abrasive layer, at least one fastening means which is designed and arranged to detachably connect the first grinding element to the second grinding element, wherein the first grinding element and the second grinding element are detachably connected to each other in a grinding position in such a way that the first grinding element and the second grinding element abut against one another.

### CROSS-REFERENCE TO RELATED APPLICATIONS

This application is a U.S. National Phase of PCT Application No. PCT/EP2024/074519 filed Sep. 3, 2024, which claims the priority to German Patent Application No. 102023123677.6 filed Sep. 4, 2023, the disclosure of which is hereby incorporated in its entirety by reference herein.

### TECHNICAL FIELD

The disclosure relates to a device for sharpening a fishing hook. Furthermore, the disclosure relates to a fishing hook system, a method for grinding a fishing hook, and a use of a device for sharpening a fishing hook.

### BACKGROUND

In angling, fishing hooks are typically used which serve for fastening a bait and for holding a caught fish on the line. Fishing hooks of different shapes and sizes are known. Fishing hooks typically have a head, a shank, a bend, a tip and optionally a barb. Fishing hooks are typically made of metal.

Fishing hook tips of fishing hooks become blunt relatively quickly and then no longer engage properly in the fish mouth. The use of a blunt fishing hook can then also lead to injuries to the fish. The blunting of fishing hooks can occur, for example, due to contacts with objects under water, such as stones, branches or underwater plants. If the fishing hooks are blunt, they become unusable. In order to enable proper engagement of the fishing hook in the fish mouth and in order to avoid injuries to the fish, the use of fishing hooks with a sharp fishing hook tip is of great importance for angling.

It is known to use grinding tools for sharpening fishing hooks or fishing hook tips. Thus, for example, it is known to use grindstones, or files, which have a grinding surface, for this purpose. However, such sharpening of fishing hooks requires a lot of practice and regularly leads to insufficient results in which the fishing hook tip is not brought back into the desired pointed shape.

The disclosure provides a solution that improves the sharpening of fishing hook tips as well the other identified problems.

### SUMMARY

According to a first aspect of the disclosure, a device for sharpening a fishing hook is provided, the device comprising a first grinding element having a first grinding surface with an abrasive layer, in particular in the form of a diamond coating, a second grinding element having a second grinding surface with an abrasive layer, in particular in the form of a diamond coating, at least one fastening means which is designed and arranged to connect the first grinding element to the second grinding element, in particular in a detachable manner, wherein the first grinding element and the second grinding element are connected to one another in a grinding position in such a manner that the first grinding element and the second grinding element abut against one another, wherein the first grinding surface of the first grinding element and the second grinding surface of the second grinding element are arranged facing one another in the grinding position in such a manner that a grinding region is formed between the first grinding surface of the first grinding element and the second grinding surface of the second grinding element, wherein the grinding region may be formed with a substantially acute-angled cross-sectional shape.

Thus, a device for sharpening a fishing hook is provided which has two grinding elements which can be detachable or permanently connected to one another. The grinding elements may be arranged in a grinding position that forms at least one grinding region defined between two grinding surfaces, which serve for sharpening a fishing hook tip.

An advantage of such a device is that sharpening of fishing hook tips is substantially facilitated by means of such a device and reliable sharpening of a fishing hook can be achieved. As a result, fishing hooks can be used significantly longer and the negative consequences of a blunt fishing hook can be avoided.

The possibility achieved by the device of is based, inter alia, on the fact that the device has a grinding region in which the fishing hook tip can be sharpened by movement of the fishing hook through this grinding region. The grinding region can be formed due to the arrangement of the components of the device relative to one another in such a manner that it already substantially corresponds to the cross-section of a tip shape of a fishing hook, i.e., a fishing hook tip. As a result, a fishing hook can also be successfully sharpened reliably by an inexperienced user.

A further advantage of such a device is that the device can be cleaned and/or maintained particularly well, since the grinding elements are connected to one another, e.g., detachably, and can be disassembled. In the disassembled state, i.e., the maintenance position, good cleaning and/or maintenance of the grinding elements can take place.

The grinding region may have an substantially acute-angled cross-sectional shape. A substantially acute-angled grinding region in cross-section is in particular to be understood as a grinding region which is acute-angled in cross-section, i.e. an angle of less than 90° is formed between the two grinding surfaces, wherein however the first and the second grinding surface do not have to be formed exactly planar in cross-section and in particular can each have a rounding. A substantially acute-angled grinding region can thus be formed as an acute-angled grinding region without roundings of the grinding planes or can be formed as an acute-angled grinding region with roundings.

The grinding region may have an angle of less than 35°, of less than 20°, or of less than 15°. The grinding region may have an angle of less than 15° and/or greater than 1°, e.g., greater than 5°.

The first grinding element and the first grinding surface may be integrally formed. However, it is also possible that the first grinding element and the first grinding surface are not integral, but are formed as separate components, e.g., as components which can be detachably connected to one another by means of a form-fitting connection.

The second grinding element and the second grinding surface may be formed integrally. However, it is also possible that the second grinding element and the second grinding surface are not integral, but are formed as separate components, in particular as components which can be detachably connected to one another by means of a form-fitting connection.

It is preferred that the first grinding element and/or the second grinding element comprises plastic and/or steel, for example of the type V4A or AISI 316. Alternatively, it is also conceivable that the first grinding element and/or the second grinding element comprises a material other than plastic and/or steel. It is further preferred that the first and/or the second abrasive layer is formed in the form of a diamond coating, in particular with a grit size of at most FEPA F 20 and at least FEPA F 320, e.g., with a grit size of FEPA F 240 or of FEPA F 180.

The grinding position is in particular to be understood as the position of the grinding elements relative to one another in which the first grinding element and the second grinding element are connected to one another, i.e. are arranged abutting against one another. In the grinding position, a fishing hook tip can accordingly be sharpened by means of the device.

Abutting of the first grinding element against the second grinding element is in particular to be understood as at least sectionwise abutting. Thus, the grinding elements can also abut against one another only in a small region or can also abut against one another over a larger area in planar fashion.

It is particularly preferred that the first grinding element has a width and a height and the first grinding element extends along the width of the first grinding element and the height of the first grinding element in a first plane, wherein the second grinding element has a width and a height and the second grinding element extends along the width of the second grinding element and the height of the second grinding element in a second plane, wherein the first plane and the second plane are arranged parallel to one another in the grinding position.

The width of the first grinding element may be smaller than the height of the first grinding element. The width of the second grinding element may be smaller than the height of the second grinding element. The height of the first grinding element may correspond to the height of the second grinding element. The width of the first grinding element may correspond to the width of the second grinding element.

It is particularly preferred that the first grinding element and the second grinding element are designed to be substantially identical.

An advantage of an identical design of the first and second grinding element is that the manufacturing costs can be reduced, since the same mold and/or tools can be used for manufacturing the first grinding element and the second grinding element, or the same molds and/or tools can be used. Moreover, in the event of wear or a defect of the first or the second grinding element, it can be replaced by using a further identical grinding element as a replacement.

The first grinding element and the second grinding element, with respect to a mirror plane along which the first grinding element and the second grinding element abut against one another, may be arranged and designed in a mirror-symmetrical manner.

The mirror plane may be arranged parallel to the first plane and to the second plane.

An advantage of such a mirror-symmetrical design is that the device can be held and used in different positions. In the case of a device used in different positions as a result, the grinding surfaces wear more uniformly, so that overall a longer service life of the grinding surfaces can be achieved than in conventional grinding tools used for sharpening fishing hooks, such as files, in which the grinding surfaces regularly wear very unevenly.

The first grinding surface and the second grinding surface may each have a surface formed in a curved manner such that one of the two grinding surfaces is formed convex and the other of the two grinding surfaces is formed concave, so that an asymmetrical, curved grinding region is formed between the first grinding surface and the second grinding surface, which may be formed as a negative shape of a curved fishing hook tip.

In one or more embodiments, the outer surface of the first grinding element is formed ribbed. As a result, better gripability is achieved and slipping in the hand during use is avoided or reduced.

The outer surface of the second grinding element may be formed ribbed. As a result, better gripability is achieved in a particularly advantageous manner and slipping in the hand during use is avoided or reduced.

The first grinding element may have a thickness and the thickness of the first grinding element is smaller by a multiple than the width of the first grinding element and/or smaller by a multiple than the height of the first grinding element, wherein the second grinding element has a thickness and the thickness of the second grinding element is smaller by a multiple than the width of the second grinding element and/or smaller by a multiple than the height of the second grinding element.

The thickness of the first grinding element may be less than 1 cm, particularly less than 0.5 cm. The thickness of the second grinding element may be less than 1 cm, particularly less than 0.5 cm.

The height of the first grinding element may be at least 5 cm, at least 6 cm, or at least 8 cm. The height of the first grinding element may be at most 20 cm, and in some embodiments, 15 cm or less.

The height of the second grinding element may be at least 5 cm, at least 6 cm, or at least 8 cm. The height of the second grinding element may be at most 20 cm, and in some embodiments 15 cm or less.

The width of the first grinding element is at least 4 cm, at least 5 cm, or at least 6 cm. The width of the first grinding element may be at most 15 cm, and in some embodiments 10 cm or less.

The width of the second grinding element may be at least 4 cm, at least 5 cm, or at least 6 cm. The width of the second grinding element may be at most 15 cm, and in some embodiments, at most 10 cm.

An advantage of such dimensions is that particularly advantageous handling of the device can be achieved thereby, since with these dimensions the device can generally be gripped particularly well by means of one hand.

In one or more embodiments, the at least one fastening means comprises a plurality of screws, preferably at least two screws, at least four screws, or at least six screws. A plurality of fastening means in the form of screws, for example six, may be used.

At least one threaded bore for receiving the at least one fastening means is arranged in the first grinding element and/or in the second grinding element. A threaded bore may be provided for each fastening means, so that each of the fastening means can be inserted into a corresponding threaded bore.

However, it is also possible that the first grinding element is not detachably connected to the second grinding element, for example by means of a material-bonding connection, preferably in the form of a welded connection.

The first grinding element may have a third grinding surface with an abrasive layer, in particular in the form of a diamond coating, wherein the second grinding element may have a fourth grinding surface with an abrasive layer, e.g., in the form of a diamond coating, wherein the third grinding surface of the first grinding element and the fourth grinding surface of the second grinding element are arranged facing one another in the grinding position in such a manner that a further grinding region is formed between the third grinding surface of the first grinding element and the fourth grinding surface of the second grinding element.

An advantage of such a further grinding region is that not only one, but two grinding regions are provided and thus also the service life of the grinding regions, i.e. in particular of the grinding surfaces, and thus of the device is significantly increased, in particular doubled. For example, after wear of the grinding surfaces which form the one grinding region, the further grinding region can be used, or the grinding regions are used uniformly so that over time uniform wear of all grinding surfaces takes place.

The further grinding region may have substantially acute-angled cross-sectional shape, i.e. with an angle of less than 90°.

The further grinding region may have an angle of less than 35°, less than 20°, or less than 15°.

The first grinding surface may be formed integrally with the first grinding element and the second grinding surface may be formed integrally with the second grinding element.

An advantage of such an integral design is that the device, apart from the at least one fastening means, only has two components, namely the first grinding element and the second grinding element. As a result, both the handling of the device for the user is improved and the manufacture of the components is simplified and the manufacturing costs can be reduced.

The first grinding surface has a height extension which extends from the lower end of the first grinding surface, at which the first grinding surface converges with and/or is in contact with the second grinding surface in the grinding position, up to the upper end of the first grinding surface, at which the first grinding surface forms the outer opening of the grinding region. The height extension of the first grinding surface may be at least 1 mm, at least 1.5 mm, at least 3 mm or at least 5 mm.

the second grinding surface may have a height extension which extends from the lower end of the second grinding surface, at which the second grinding surface converges with and/or is in contact with the first grinding surface in the grinding position, up to the upper end of the second grinding surface, at which the second grinding surface forms the outer opening of the grinding region. The height extension of the second grinding surface may be at least 1 mm, at least 1.5 mm, at least 3 mm or at least 5 mm.

The height extension of the first grinding surface and the height extension of the second grinding surface may be identical.

The height extension of the first grinding surface and the height extension of the second grinding surface may not be identical. The height extension of the second grinding surface may be larger by a multiple, at least three times as large, as the height extension of the first grinding surface. As a result, it can be achieved in a particularly advantageous manner that a fishing hook is pressed in a first step against the second grinding surface, and in particular against the second abrasive layer, and is moved along the second grinding surface, and in particular the second abrasive layer, in order to grind the entire fishing hook tip, and then in a next step the fishing hook is rotated, for example by 90°, and then pressed against the first grinding surface, and in particular the first abrasive layer, and moved along the first grinding surface, and in particular the first abrasive layer, in order to grind only the foremost section of the fishing hook tip. As a result, a particularly sharp fishing hook can be produced.

The height extension of the first abrasive layer and the height extension of the second abrasive layer may not be identical. The height extension of the second abrasive layer may be larger by a multiple, at least three times as large, as the height extension of the first abrasive layer. As a result, it can be achieved in a particularly advantageous manner that a fishing hook is pressed in a first step against the second abrasive layer and is moved along the second abrasive layer in order to grind the entire fishing hook tip, and then in a next step the fishing hook is rotated, for example by 90°, and then pressed against the first abrasive layer and moved along the first abrasive layer in order to grind only the foremost section of the fishing hook tip. As a result, a particularly sharp fishing hook can be produced.

The first grinding surface may have a longitudinal extension arranged perpendicular to the height extension. The first grinding surface may have two mutually spaced partial abrasive layers, namely a first partial abrasive layer of the first grinding surface and a second partial abrasive layer of the first grinding surface. The first partial abrasive layer of the first grinding surface may have a larger extension, larger by a multiple, in the direction of the longitudinal extension of the first grinding surface. The first grinding surface may have at least one uncoated region which is arranged between the first partial abrasive layer of the first grinding surface and the second partial abrasive layer of the first grinding surface. A plurality of uncoated regions may also be provided. This makes it possible that a fishing hook is moved in a first step along the first partial abrasive layer of the first grinding surface, and then in a next step the fishing hook is rotated, for example by 90°, and then moved along the second partial abrasive layer of the first grinding surface, whereby a particularly sharp foremost section of the fishing hook can be achieved.

The second grinding surface may have a longitudinal extension arranged perpendicular to the height extension. The second grinding surface may have two mutually spaced partial abrasive layers, namely a first partial abrasive layer of the second grinding surface and a second partial abrasive layer of the second grinding surface. The first partial abrasive layer of the second grinding surface may have a larger extension, larger by a multiple, in the direction of the longitudinal extension of the second grinding surface. The second grinding surface may have at least one uncoated region which is arranged between the first partial abrasive layer of the second grinding surface and the second partial abrasive layer of the second grinding surface. A plurality of uncoated regions may also be provided. This makes it possible that a fishing hook is moved in a first step along the first partial abrasive layer of the second grinding surface, and then in a next step the fishing hook is rotated, for example by 90°, and then moved along the second partial abrasive layer of the second grinding surface, whereby a particularly sharp foremost section of the fishing hook can be achieved.

The first grinding element may have a first recess, which may be arranged between the first grinding surface of the first grinding element and the third grinding surface of the first grinding element.

An advantage of such a recess is that material can be saved by means of such a recess and additionally the weight of the device can be reduced. A further advantage is that during use of the device a finger or a plurality of fingers can be guided into the recess, whereby the device can be held more securely and slipping of the device or of the fishing hook during sharpening is avoided.

The second grinding element may have a second recess, which may be arranged between the second grinding surface of the second grinding element and the fourth grinding surface of the second grinding element.

The first recess and the second recess may be designed identically.

The first grinding element may have a first gripping region and a second gripping region, wherein the first gripping region and the second gripping region are each formed to be inwardly curved in the direction of the center point of the first grinding element, in particular in the direction of the first recess of the first grinding element, wherein the second grinding element has a third gripping region and a fourth gripping region, wherein the third gripping region and the fourth gripping region are each formed to be inwardly curved in the direction of the center point of the second grinding element, in particular in the direction of the second recess of the second grinding element.

An advantage of such a gripping region is that material can be saved by means of such a gripping region and additionally the weight of the device can be reduced. A further advantage is that during use of the device the device can be held more securely and slipping of the device or of the fishing hook during sharpening can be avoided.

The first grinding element and the second grinding element may be arrangeable in a maintenance position, in which the at least one fastening means is released and the first grinding element and the second grinding element are not connected to one another.

An advantage of the possibility of arranging the device in the maintenance position is that cleaning of the device is possible significantly more easily and thoroughly. Moreover, another arrangement of the grinding elements relative to one another is also possible when the grinding elements are reassembled and connected to one another, for example rotated relative to one another by 180°. Through the good cleaning possibility, the service life of the device can be increased.

The first grinding element may have a first rod element with a substantially semicircular cross-section, wherein the first grinding surface is arranged on the first rod element, wherein the first rod element is arranged in the grinding position in a form-fitting manner in a receiving region of a first grinding element body of the first grinding element.

The second grinding element may have a second rod element with a substantially semicircular cross-section, wherein the second grinding surface is arranged on the second rod element, wherein the second rod element is arranged in the grinding position in a form-fitting manner in a receiving region of a second grinding element body of the second grinding element.

A clamping screw may be designed and arranged to detachably clamp the first rod element and the second rod element against one another.

The two rod elements may be designed with the same length. The first grinding element body and the second grinding element body may be designed with the same length. The two rod elements may be designed longer than the grinding element bodies, so that the rod elements project out of the grinding element bodies, on both sides. The rod elements may project out on both sides of the grinding element bodies with the same length. However, it is also conceivable that the rod elements project out further on one side of the grinding element bodies than on the other side.

According to a further aspect, the object stated at the outset is achieved by a fishing hook system, comprising a fishing hook with a fishing hook tip having a substantially acute-angled cross-sectional shape, and a device as described herein, wherein the grinding region formed between the first grinding surface of the first grinding element and the second grinding surface of the second grinding element has a cross-sectional shape which is adapted to the cross-sectional shape of the fishing hook tip of the fishing hook and/or corresponds to the cross-sectional shape of the fishing hook tip of the fishing hook.

An advantage of such corresponding cross-sectional shapes of the fishing hook and of the grinding region is that exactly the desired shape of the fishing hook tip can be restored with the device.

A further grinding region may also be provided, which is likewise adapted to the shape of the fishing hook tip and which is accordingly formed like the first grinding region, which is merely arranged rotated by 180° relative to the first grinding region.

According to a further aspect, a method for grinding a fishing hook comprises providing a fishing hook system as described herein, arranging the device in the grinding position and grinding the fishing hook by moving the fishing hook tip along the grinding region of the device, arranging the device in a maintenance position and cleaning the first grinding element and the second grinding element, in particular the first grinding surface and the second grinding surface.

According to a further aspect, the object stated at the outset is achieved by a use of a device as described herein for sharpening a fishing hook tip of a fishing hook, in particular by carrying out the method described herein.

With regard to the advantages, embodiments and embodiment details of the various aspects of the solutions described herein and their respective possible developments, reference is also made to the description of the corresponding features, details and advantages of the respective other aspects and their developments.

### BRIEF DESCRIPTION OF THE DRAWINGS

Exemplary embodiments are explained by way of example with reference to the accompanying figures. The drawings are not necessarily to scale. In the figures, identical or substantially functionally identical or similar elements are designated with the same reference signs.

FIG. 1 is a perspective view of a first embodiment of a device for sharpening a fishing hook;

FIG. 2a is a first side view of the first embodiment shown in FIG. 1;

FIG. 2b is a second side view of the first embodiment shown in FIG. 1;

FIG. 2c is a side view of a further embodiment of a device for sharpening a fishing hook;

FIG. 2d is a side view of a further embodiment of a device for sharpening a fishing hook;

FIG. 2e is a side view of a further embodiment of a device for sharpening a fishing hook.

FIG. 3a is a sectional view of a detail of the first embodiment shown in FIG. 1;

FIG. 3b is a partial view of a second grinding element of the first embodiment shown in FIG. 1;

FIG. 4a is a perspective view of the partial detail shown in FIG. 3b of the first embodiment shown in FIG. 1;

FIG. 4b is a schematic representation of components of a fishing hook system;

FIG. 4c is a schematic representation of components of a fishing hook system;

FIG. 4d is partial views of a first grinding element and a second grinding element of a further embodiment;

FIG. 4e is a partial view of a second grinding element of a further embodiment;

FIG. 4f is a sectional view of a detail of a further embodiment of a device for sharpening a fishing hook and two perspective views of this embodiment;

FIG. 5 is a side view of a second embodiment of a device for sharpening a fishing hook;

FIG. 6a is a perspective view of a third embodiment of a device for sharpening a fishing hook;

FIG. 6b is a sectional view of the third embodiment shown in FIG. 6a;

FIG. 7a is perspective view of a rod element of the third embodiment shown in FIG. 6a;

FIG. 7b is a perspective view of a grinding element body of the third embodiment shown in FIG. 6a;

FIG. 8 is a schematic representation of a method for grinding a fishing hook.

### DETAILED DESCRIPTION

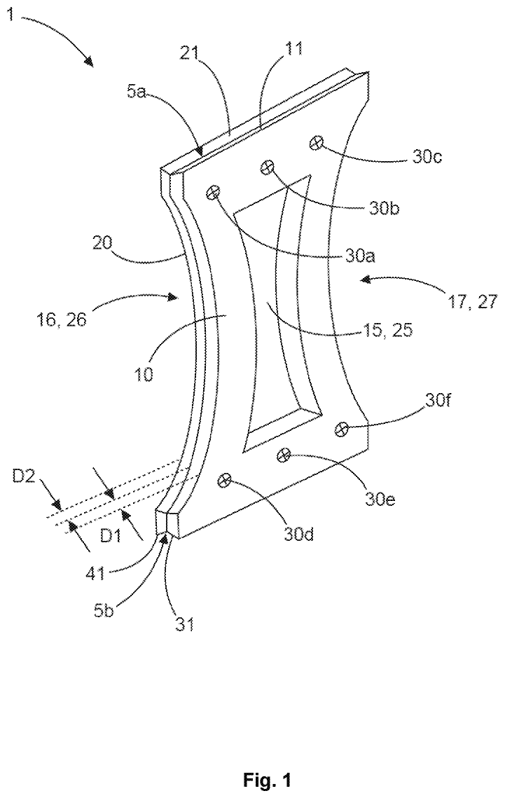

FIG. 1 shows a perspective view of a first embodiment of a device 1 for sharpening a fishing hook in a grinding position. The device 1 comprises a first grinding element 10 which has a first grinding surface 11 with an abrasive layer, in particular in the form of a diamond coating, and a second grinding element 20 which has a second grinding surface 21 with an abrasive layer, in particular in the form of a diamond coating. A plurality of fastening means 30a, 30b, 30c, 30d, 30e, 30f are provided, which are designed and arranged to detachably connect the first grinding element 10 to the second grinding element 20. The fastening means 30a, 30b, 30c, 30d, 30e, 30f are designed in the form of screws which are arranged in threaded bores and are detachably screwed into the threaded bores. As a result, the first grinding element 10 and the second grinding element 20 are connected to one another in the grinding position shown here in such a manner that the first grinding element 10 and the second grinding element 20 abut against one another, wherein the first grinding surface 11 of the first grinding element 10 and the second grinding surface 21 of the second grinding element 20 are arranged facing one another in such a manner that a grinding region 5a is formed between the first grinding surface 11 of the first grinding element 10 and the second grinding surface 21 of the second grinding element 20. A further grinding region 5b is formed between a third grinding surface 31 of the first grinding element 10 and a fourth grinding surface 41 of the second grinding element 20.

The first grinding element 10 has a first recess 15 which is arranged between the first grinding surface 11 of the first grinding element 10 and the third grinding surface 31 of the first grinding element 10. The second grinding element 20 has a second recess 25 which is arranged between the second grinding surface 21 of the second grinding element 20 and the fourth grinding surface 41 of the second grinding element 20. The first recess 15 and the second recess 25 are designed identically and lie congruently one above the other.

The first grinding element 10 has a first gripping region 16 and a second gripping region 17, wherein the first gripping region 16 and the second gripping region 17 are each formed to be inwardly curved in the direction of a center point M1 of the first grinding element 10, in particular in the direction of the first recess of the first grinding element 10. The second grinding element 20 has a third gripping region 26 and a fourth gripping region 27, wherein the third gripping region 26 and the fourth gripping region 27 are each formed to be inwardly curved in the direction of a center point M2 of the second grinding element 20, in particular in the direction of the second recess of the second grinding element 20.

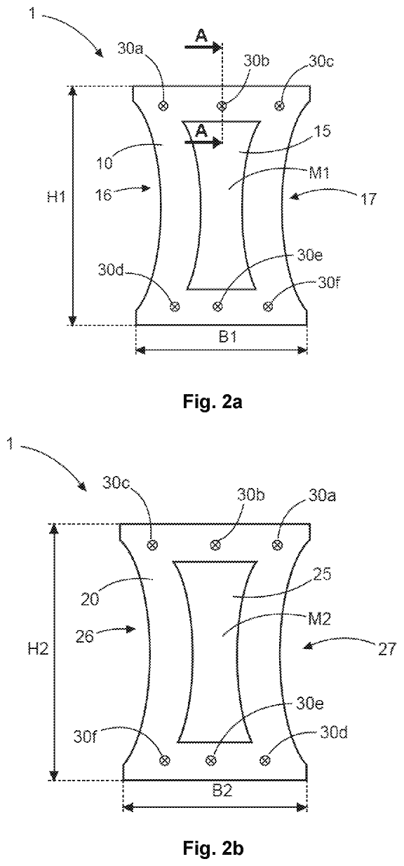

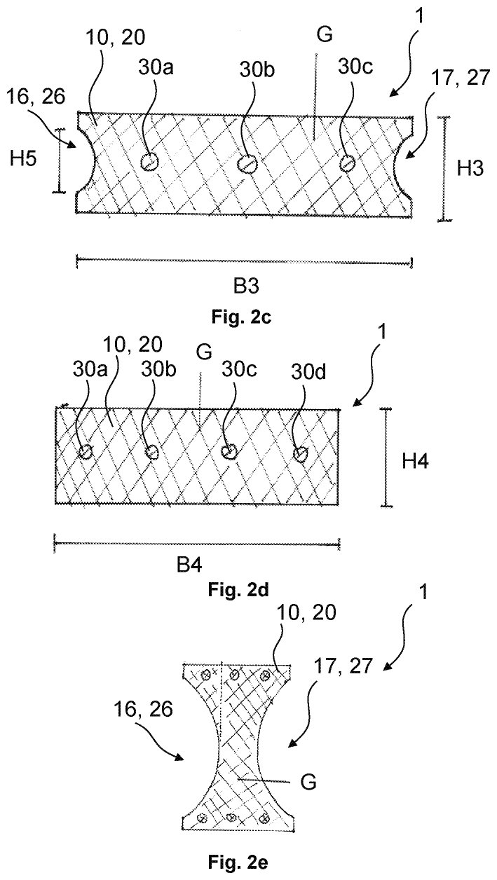

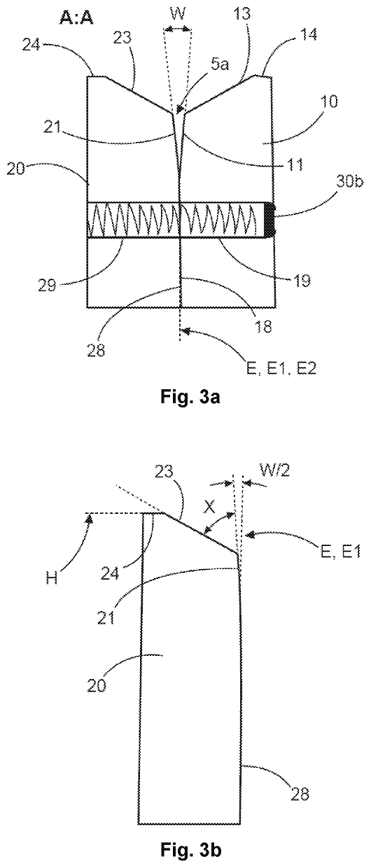

FIG. 2a shows a first side view of the first embodiment of the device 1 shown in FIG. 1. The first grinding element 10 has a width B1 and a height H1. The first grinding element 10 extends along the width B1 of the first grinding element 10 and the height B1 of the first grinding element 10 in a first plane El (see FIGS. 3a, 3b). The second grinding element 20 has a width B2 and a height H2 and extends along the width B2 of the second grinding element 10 and the height H2 of the second grinding element 20 in a second plane E2 (see FIG. 3a). The first plane El and the second plane E2 are arranged parallel to one another in the grinding position.

The height H1 of the first grinding element 10 and the height of the second grinding element 20 are for example each 8 cm. The width B1 of the first grinding element 10 and the width B2 of the second grinding element are for example each 6 cm.

FIG. 2b shows a second side view of the first embodiment shown in FIG. 1. In this view, the second grinding element 20 is shown from the side, i.e. the side of the device opposite the side shown in FIG. 2a. The second grinding element 20 is designed like the first grinding element 10.

FIG. 2c shows a side view of a further embodiment of a device 1 for sharpening a fishing hook. The first grinding element 10 has a width B3 and a height H3. The recess 16 has the height H5. The same applies to the recess 17. The outer surface G of the first grinding element 10 is formed ribbed. The second grinding element 20 has a corresponding shape. The second grinding element 20 has a width B3 and a height H3. The recess 16 has the height H5. The same applies to the recess 17. The outer surface G of the second grinding element 20 is formed ribbed.

FIG. 2d shows a side view of a further embodiment of a device 1 for sharpening a fishing hook. The first grinding element 10 has a width B4 and a height H4. The first grinding element 10 has a rectangular shape and no lateral recesses. The outer surface G of the first grinding element 10 is formed ribbed. The second grinding element 20 has a corresponding shape. The second grinding element 20 has a width B4 and a height H4. The outer surface G of the second grinding element 20 is formed ribbed.

FIG. 2e shows a side view of a further embodiment of a device 1 for sharpening a fishing hook. The outer surface G of the first grinding element 10 and the outer surface of the second grinding element 20 are each formed ribbed. In this embodiment, lateral recesses 16, 17, 26, 27 are provided.

FIG. 3a shows a sectional view of a detail of the first embodiment shown in FIG. 1 in the region of the grinding region 5a. The fastening screw 30b has been guided through the bores 19, 29, which are provided at least partially with a thread for receiving the fastening screw 30b, and is arranged in the bores 19, 29. As a result, the first grinding element 10 and the second grinding element 20 are held against one another. The first grinding element 10 extends in the plane El. The second grinding element 20 extends in the plane E2 and the grinding elements 10, 20 are designed and arranged mirror-symmetrically with respect to the plane E. The planes E1, E2, E are arranged parallel to one another. The first grinding element 10 lies with the surface 18 against the surface 28 of the second grinding element 20 in planar fashion.

The grinding region 5a is formed by the first grinding surface 11 and the second grinding surface 21. Due to the arrangement of the first and second grinding surfaces 11, 21, the grinding region 5a has an acute-angled cross-sectional shape which has the angle W which in the embodiment shown here is approximately 10°. Adjacent to the first grinding surface 11, a further plane 13 is arranged, which is arranged at a certain angle relative to the first grinding surface 11. Furthermore, a further plane 14 is arranged adjacent to the plane 13, which in turn is rotated relative to the plane 13 by a certain angle. Adjacent to the second grinding surface 21, a further plane 23 is arranged, which is arranged at a certain angle x (see FIG. 3b), which is approximately 45°, relative to the second grinding surface 21. Furthermore, a further plane 24 is arranged adjacent to the plane 23, which in turn is rotated relative to the plane 23 by a certain angle.

FIG. 3b shows a partial view of a second grinding element 20 of the first embodiment shown in FIG. 1. Here, the partial detail of the second grinding element 20 from the view shown in FIG. 3a is shown (however not sectioned). The plane 24 extends in the erected state of the device substantially in horizontal direction H.

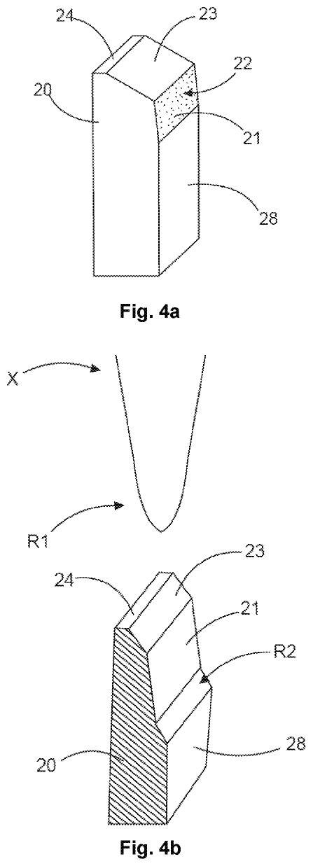

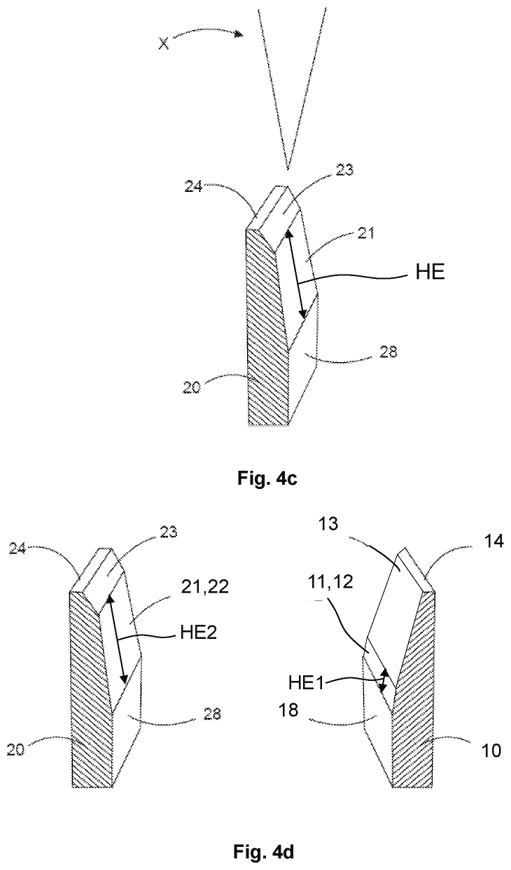

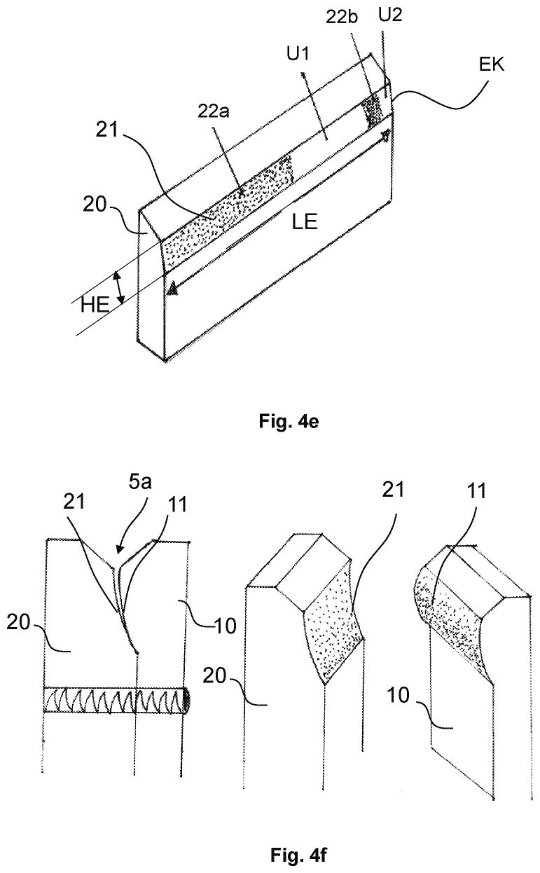

FIG. 4a shows a perspective view of the partial detail shown in FIG. 3b of the first embodiment shown in FIG. 1. The second grinding surface 21 has a diamond coating 22.

FIG. 4b shows a schematic representation of components of a fishing hook system. The fishing hook tip X has a slight rounding R1 at the end of the tip. The second grinding element 20 has a second grinding surface 21 which likewise has a slight rounding R2 in the lower region. The rounding R2 is designed such that it substantially corresponds to the rounding R1 of the fishing hook tip.

FIG. 4c shows a schematic representation of components of a fishing hook system. The fishing hook tip X has a tip which has a taper which extends in a substantially constant manner up to the end of the fishing hook tip X. The second grinding element 20 has a second grinding surface 21 which extends in a plane. The second grinding surface is designed such that it substantially corresponds to the angle of the outer surface of the fishing hook tip X. The second grinding surface 21 has a height extension HE which extends from the lower end of the second grinding surface 21, at which the second grinding surface 21 converges with and/or is in contact with the first grinding surface in the grinding position, up to the upper end of the second grinding surface 21, at which the second grinding surface 21 forms the outer opening of the grinding region. The height extension HE of the second grinding surface 21 is at least 1 mm, at least 1.5 mm, and/or at most 5 mm, e.g., at most 3 mm. The first grinding surface (not shown here) likewise has a corresponding height extension which extends from the lower end of the first grinding surface, at which the first grinding surface converges with and/or is in contact with the second grinding surface 21 in the grinding position, up to the upper end of the first grinding surface, at which the first grinding surface forms the outer opening of the grinding region. The height extension of the first grinding surface likewise is at least 1 mm, at least 1.5 mm, and/or at most 5 mm, e.g., at most 3 mm.

FIG. 4d shows partial views of a first grinding element 10 and a second grinding element 20 of a further embodiment. The height extension HE1 of the first grinding surface 11, which here is identical with the height extension of the first abrasive layer 12, and the height extension HE2 of the second grinding surface 21, which here is identical with the height extension of the second abrasive layer 22, are not identical. The height extension HE2 of the second grinding surface 21, and thus also the height extension of the second abrasive layer 22, is larger by a multiple, e.g., at least three times as large, as the height extension HE1 of the first grinding surface 11, and thus also the height extension of the first abrasive layer 12. This makes it possible that a fishing hook is pressed in a first step against the second grinding surface 21 and is moved along the second grinding surface 21 in order to grind the entire fishing hook tip, and then in a next step the fishing hook is rotated, for example by 90°, and then pressed against the first grinding surface 11 and moved along the first grinding surface 11 in order to grind only the foremost section of the fishing hook tip.

FIG. 4e shows a partial view of a second grinding element 20 of a further embodiment. The longitudinal extension LE of the second grinding surface 21 extends perpendicular to the height extension HE of the second grinding surface 21. The grinding surface 21 has two mutually spaced partial abrasive layers 22a, 22b, namely a first partial abrasive layer 22a and a second partial abrasive layer 22b, in the form of diamond coatings. Between the two partial abrasive layers 22a, 22b, which are arranged along the longitudinal extension LE of the second grinding surface 21, an uncoated section U1 is arranged which has no abrasive layer and thus also no diamond coating. Furthermore, between an edge EK of the grinding element 20 and the second partial abrasive layer 22b a further uncoated section U2 is arranged. The first partial abrasive layer 22a of the second grinding surface 21 and the second partial abrasive layer 22b of the second grinding surface 21 may have different extensions in the direction of the longitudinal extension of the second grinding surface 21. This makes it possible that a fishing hook is moved in a first step along the first partial abrasive layer 22a of the second grinding surface 21, and then in a next step the fishing hook is rotated, for example by 90°, and then moved along the second partial abrasive layer 22b of the second grinding surface 21.

FIG. 4f shows a sectional view of a detail of a further embodiment of a device for sharpening a fishing hook and two perspective views of this embodiment. The first grinding surface 11 and the second grinding surface 21 each have a surface formed in a curved manner such that one of the two grinding surfaces 11, 21 is formed convex and the other of the two grinding surfaces 11, 21 is formed concave, so that an asymmetrical, curved grinding region 5a is formed between the first grinding surface 11 and the second grinding surface 21, which is formed as a negative shape of a curved fishing hook tip.

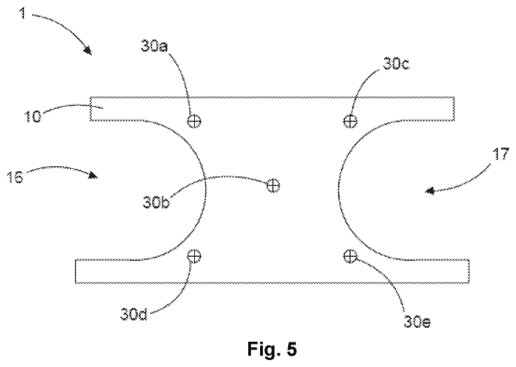

FIG. 5 shows a side view of a second embodiment of a device 1 for sharpening a fishing hook. The first grinding element 10 has a first gripping region 16 and a second gripping region 17, wherein the first gripping region 16 and the second gripping region 17 are each formed to be inwardly curved in the direction of a center point of the first grinding element 10. The curvature is in each case formed semicircular. The fastening screws 30a, 30b, 30c, 30d, 30e are arranged in an X-shape, i.e. with four fastening screws which are arranged at the corners of a rectangle, in particular square, wherein in the middle of these screws a central fastening screw is arranged.

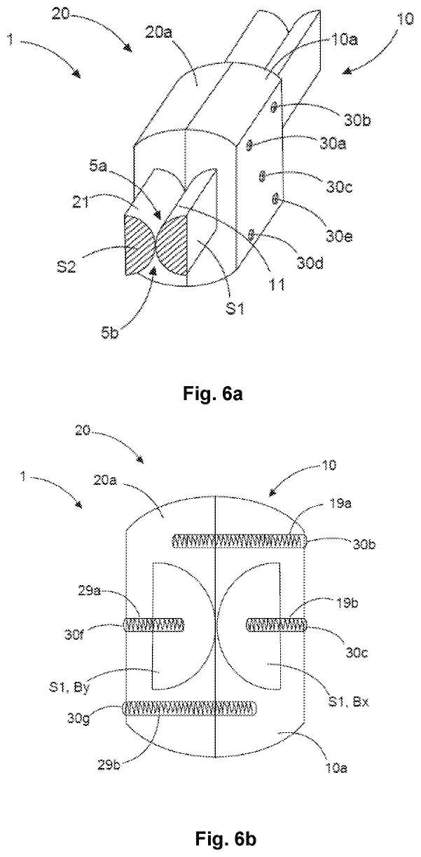

FIG. 6a shows a perspective view of a third embodiment of a device for sharpening a fishing hook in a grinding position. In this embodiment, the first grinding element 10 has a first rod element S1 with a substantially semicircular cross-section. The first grinding surface 11 is arranged on the first rod element S1. The first rod element S1 is arranged in the grinding position in a form-fitting manner in a receiving region Bx (see FIG. 6b) of a first grinding element body 10a of the first grinding element 10. The second grinding element 20 has a second rod element S2 with a substantially semicircular cross-section. The second grinding surface 21 is arranged on the second rod element S2, wherein the second rod element S2 is arranged in the grinding position in a form-fitting manner in a receiving region By (see FIG. 6b) of a second grinding element body 20a of the second grinding element 20. In this embodiment, the first grinding element 10 thus comprises the first grinding element body 10a and the first rod element S1. And the second grinding element 20 thus comprises the second grinding element body 20a and the second rod element S2. Two clamping screws 30c, 30f are provided in order to detachably clamp the first rod element S1 and the second rod element S2 against one another. The grinding region 5a is formed between the first grinding surface 11 of the first rod element S1 and the second grinding surface 21 of the second rod element S2. In addition, a further grinding region 5b is also formed between the first grinding surface 11 of the first rod element S1 and the second grinding surface 21 of the second rod element S2, namely on the side opposite the first grinding region 5a with respect to the contact line between the two rod elements S1, S2. The two rod elements S1, S2 may be designed with the same length. The first grinding element body 10a and the second grinding element body 20a may be designed with the same length. The two rod elements S1, S2 may be designed longer than the first grinding element body 10a and the second grinding element body 20a, so that the rod elements S1, S2 project out of the grinding element bodies 10a, 20a, e.g., on both sides. The rod elements S1, S2 can either project out further on one side of the grinding element bodies 10a, 20a than on the other side (as shown by way of example in FIG. 6a), or can project out with the same length on both sides of the grinding element bodies 10a, 20a.

FIG. 6b shows a sectional view of the third embodiment shown in FIG. 6a. The fastening screws are arranged here somewhat differently from the view shown in FIG. 6a. Otherwise, the embodiment shown here corresponds to the embodiment shown in FIG. 6a, so that reference is made in this respect to the explanations regarding FIG. 6a.

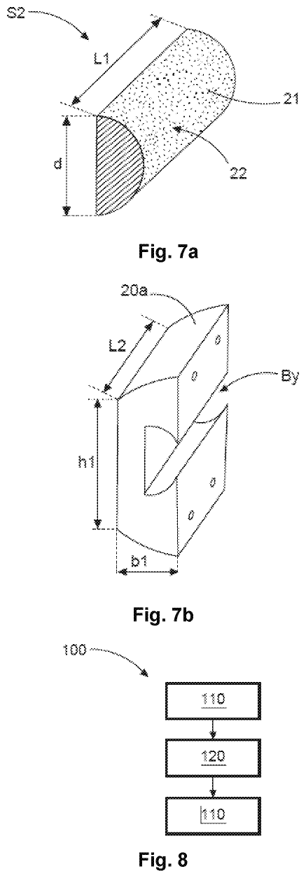

FIG. 7a shows a perspective view of a rod element S2 of the third embodiment shown in FIG. 6a. The rod element S2 has a length L1 which may be longer than the length L2 of the grinding element body 20a (see FIG. 7b). The rod element furthermore has a diameter d. The grinding surface 21 has a diamond coating 22.

FIG. 7b shows a perspective view of a grinding element body 20a of the third embodiment shown in FIG. 6a. The grinding element body 20a has a receiving region By for receiving the rod element S2 shown in FIG. 7a. The grinding element body 20a has a width b1, a height hl and a length L2. The grinding element body 20a together with the rod element S2 shown in FIG. 7a forms the second grinding element. The first grinding element is constructed correspondingly (see FIGS. 6a and 6b).

FIG. 8 shows a schematic representation of a method 100 for grinding a fishing hook. The method comprises the following steps: In a step 110, providing a fishing hook system comprising a fishing hook with a fishing hook tip X having an substantially acute-angled cross-sectional shape, and a device 1, wherein the grinding region 5a formed between the first grinding surface 11 of the first grinding element 10 and the second grinding surface 21 of the second grinding element 20 has a cross-sectional shape which is adapted to the cross-sectional shape of the fishing hook tip X of the fishing hook and/or corresponds to the cross-sectional shape of the fishing hook tip X of the fishing hook. In a step 120, arranging the device 1 in the grinding position and grinding the fishing hook by moving the fishing hook tip along the grinding region 5a of the device 1. In a step 130, arranging the device 1 in a maintenance position and cleaning the first grinding element 10 and the second grinding element 20, in particular the first grinding surface 11 and the second grinding surface 21.

### LIST OF REFERENCE SIGNS

1 device
5a grinding region
5b further grinding region
10 first grinding element
10a first grinding element body
11 first grinding surface
12 first abrasive layer
13, 14 planes of the first grinding element
15 first recess
16 first gripping region of the first grinding element
17 second gripping region of the first grinding element
18 surface of the first grinding element
19 bore of the first grinding element
20 second grinding element
20a first grinding element body
21 second grinding surface
22 second abrasive layer
23, 24 planes of the second grinding element
25 second recess
26 second gripping region of the second grinding element
27 second gripping region of the second grinding element
28 surface of the second grinding element
29 bore of the second grinding element
30a-g fastening means
31 third grinding surface
41 fourth grinding surface
110, 120, 130 method steps
B1, B2 width of the first and the second grinding element
Bx, By receiving regions
D1, D2 thickness of the first and the second grinding element
E mirror plane
E1, E2 planes of the first and the second grinding element
H1, H2 height of the first and the second grinding element
M1, M2 center point of the grinding elements
S1, S2 first and second rod element
W angle of the grinding region opening
X fishing hook tip

1. A device for sharpening a fishing hook comprising
a first grinding element having a first grinding surface with an abrasive layer; and
a second grinding element having a second grinding surface with an abrasive layer; wherein
the first grinding element is detachably fastened to the second grinding element,
the first grinding element and the second grinding element are connected to one another in a grinding position in such a manner that the first grinding element and the second grinding element abut against one another,
the first grinding surface of the first grinding element and the second grinding surface of the second grinding element are arranged facing one another in the grinding position in such a manner that a grinding region is formed between the first grinding surface of the first grinding element and the second grinding surface of the second grinding element and
the grinding region is formed with an acute-angled cross-sectional shape.

2. The device of claim 1,
wherein the first grinding element has a width and a height, and the first grinding element extends along the width of the first grinding element and the height of the first grinding element in a first plane.
wherein the second grinding element has a width and a height and the second grinding element extends along the width of the second grinding element and the height of the second grinding element in a second plane, and
wherein the first plane and the second plane are arranged parallel to one another in the grinding position.

3. The device of claim 1, wherein the first grinding element and the second grinding element are identical.

4. The device of claim 1,
wherein the first grinding element has a thickness and the thickness of the first grinding element is smaller by a multiple than the width of the first grinding element or smaller by a multiple than the height of the first grinding element, and
wherein the second grinding element has a thickness, and the thickness of the second grinding element is smaller by a multiple than the width of the second grinding element and/or smaller by a multiple than the height of the second grinding element.

5. The device of claim 1,
wherein the height of the first grinding element is at least 5 cm, or
wherein the height of the second grinding element is at least 5 cm, or
wherein the width of the first grinding element is at least 4 cm, or
wherein the width of the second grinding element is at least 4 cm.

6. The device of claim 1, wherein the first and second grinding elements are detachably fastened by at least two screws.

7. The device of claim 1,
wherein the first grinding element has a third grinding surface with an abrasive layer,
wherein the second grinding element has a fourth grinding surface with an abrasive layer,
wherein the third grinding surface of the first grinding element and the fourth grinding surface of the second grinding element are arranged facing one another in the grinding position in such a manner that a further grinding region is formed between the third grinding surface of the first grinding element and the fourth grinding surface of the second grinding element, and
wherein the further grinding region is formed with an acute-angled cross-sectional shape.

8. The device of claim 1,
wherein the first grinding surface is formed integrally with the first grinding element and wherein the second grinding surface is formed integrally with the second grinding element, and
wherein the abrasive layer of the first grinding surface has (i) a first partial abrasive layer of the first grinding surface and a second partial abrasive layer of the first grinding surface that are spaced apart, and (ii) an uncoated region arranged between the first partial abrasive layer of the first grinding surface and the second partial abrasive layer of the first grinding surface, or
wherein the abrasive layer of the second grinding surface has a first partial abrasive layer of the second grinding surface and a second partial abrasive layer of the second grinding surface that are spaced part, and an uncoated region arranged between the first partial abrasive layer of the second grinding surface and the second partial abrasive layer of the second grinding surface.

9. The device of claim 1,
wherein the first grinding element has a third grinding surface with an abrasive layer, and the second grinding element has a fourth grinding surface with an abrasive layer, and
wherein the first grinding element has a first recess arranged between the first grinding surface of the first grinding element and the third grinding surface of the first grinding element, or
wherein the second grinding element has a second recess arranged between the second grinding surface of the second grinding element and the fourth grinding surface of the second grinding element.

10. The device of claim 1,
wherein the first grinding element has a first gripping region and a second gripping region that are each formed to be inwardly curved in the direction of a center point of the first grinding element,
wherein the second grinding element has a third gripping region and a fourth gripping region that are each formed to be inwardly curved in the direction of a center point of the second grinding element.

11. The device of claim 1, wherein the first grinding element and the second grinding element are arrangeable in a maintenance position in which the first grinding element and the second grinding element are not connected to one another.

12. The device of claim 1,
wherein the first grinding element has a first rod element defining the first grinding surface, or
wherein the second grinding element has a second rod element defining the second grinding surface.

13. A fishing hook system comprising:
a fishing hook with a fishing hook tip; and
the device of claim 1,
wherein the grinding region formed between the first grinding surface of the first grinding element and the second grinding surface of the second grinding element has a cross-sectional shape that corresponds to a cross-sectional shape of the fishing hook tip.

14. A method for grinding a fishing hook comprising:
providing the fishing hook system of claim 13,
arranging the device in the grinding position and grinding the fishing hook by moving the fishing hook tip along the grinding region of the device,
arranging the device in a maintenance position and cleaning the first grinding element and the second grinding element

15. (canceled)

16. The device of claim 1, wherein the first grinding element and the second grinding element, with respect to a mirror plane along which the first grinding element and the second grinding element abut against one another, are arranged and designed in a mirror-symmetrical manner.

17. The device of claim 7, wherein the third grinding surface has a diamond coating.

18. The device of claim 17, wherein the fourth grinding surface has a diamond coating.
